(19) United States
(12) Patent Application Publication
(10) Pub. No.: US 2017/0288290 A1
(43) Pub. Date: Oct. 5, 2017

(54) ELECTRICAL CABLE

(71) Applicant: Intel Corporation, Santa Clara, CA (US)

(72) Inventors: Sasha N. Oster, Chandler, AZ (US); Adel A. Elsherbini, Chandler, AZ (US); Kemal Aygun, Chandler, AZ (US); Robert L. Sankman, Phoenix, AZ (US)

(73) Assignee: Intel Corporation, Santa Clara, CA (US)

(21) Appl. No.: 15/087,802

(22) Filed: Mar. 31, 2016

(51) Int. Cl. H01P 3/06; H01B 11/18; G06F 1/16

(52) U.S. Cl. CPC H01P 3/06; G06F 1/16; H01B 11/1891

(57) ABSTRACT

Electrical cable technology is disclosed. In one example, an electrical cable can include a transmission line conductor, a ground conductor, and a dielectric material. The dielectric material can have at least a portion with a thickness separating the transmission line conductor and the ground conductor that is variable along a length of the electrical cable. Such a non-uniform cable (e.g., a cable having components or features that vary in size and/or geometry along the length of the cable) can provide high IO density with acceptable conductive losses and cross-talk while maintaining a desired impedance.

### TECHNICAL FIELD

Embodiments described herein relate generally to interconnection of electronic components, and more particularly to electrical cables.

### BACKGROUND

There is increasing demand to connect very high bandwidth interconnects to semiconductor packages in high-performance computing (HPC) and server applications. Traditionally, signals in HPC and server applications are routed from a die on a package, through the package, and through socket pins that serve as an electrical interface between the package and a HPC/server board. However, socket pins are unable to support increasingly high data rates with acceptable signal integrity. One alternative to relying on socket pins to support high-speed data rates, is to include a cable/connector type connection directly to a top side of a package.

### BRIEF DESCRIPTION OF THE DRAWINGS

Invention features and advantages will be apparent from the detailed description which follows, taken in conjunction with the accompanying drawings, which together illustrate, by way of example, various embodiments; and, wherein:

FIG. 1 is a schematic representation of an electronic system in accordance with an example;

FIG. 2 illustrates a detailed side view of an electrical cable and an electronic component of the electronic system of FIG. 1;

FIG. 3 illustrates a top view of the electrical cable of FIG. 2;

FIG. 4A illustrates a top view of an electrical cable in accordance with an example;

FIG. 4B illustrates a side view of the electrical cable of FIG. 4A;

FIG. 5 illustrates a side view of a multilayer electrical cable in accordance with an example;

FIG. 6 illustrates a side view of a multilayer electrical cable in accordance with another example;

FIG. 7 illustrates a side view of a multilayer electrical cable in accordance with yet another example;

FIG. 8 illustrates a side view of an electrical cable in accordance with an example;

FIG. 9 illustrates a side view of an electrical cable in accordance with another example;

FIG. 10 illustrates a side view of a multilayer electrical cable in accordance with yet another example;

FIG. 11A illustrates a side view of a coaxial electrical cable in accordance with an example; and

FIG. 11B illustrates an end view of the coaxial electrical cable of FIG. 11A.

Reference will now be made to the exemplary embodiments illustrated, and specific language will be used herein to describe the same. It will nevertheless be understood that no limitation of the scope or to specific invention embodiments is thereby intended.

### DESCRIPTION OF EMBODIMENTS

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a conductor” includes a plurality of such conductors.

In this specification, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used in this specification, the term “about” when used in connection with a numerical value is used to provide flexibility by providing that the given numerical value may be “a little above” or “a little below” the value. It is to be understood that in the written description any numerical value accompanied by the term “about” also provide express support for the numerical value per se.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, sizes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Furthermore, the described features, structures, or characteristics may be combined in any suitable manner in one or more embodiments. In this description, numerous specific details are provided, such as examples of layouts, distances, network examples, etc. One skilled in the relevant art will recognize, however, that many variations are possible without one or more of the specific details, or with other methods, components, layouts, measurements, etc. In other instances, well-known structures, materials, or operations are not shown or described in detail but are considered well within the scope of the disclosure.

### Example Embodiments

An initial overview of technology embodiments is provided below and specific technology embodiments are then described in further detail. This initial summary is intended to aid readers in understanding the technology more quickly but is not intended to identify key or essential features of the technology nor is it intended to limit the scope of the claimed subject matter.

As currently implemented, the cables typically utilized in HPC/server designs to support high-speed data rates are twin-axial cables (“twinax”). Twinax cables, however, present problems for scaling cable input/output (IO) density, which is to be maximized for connecting to the limited space available on packages. Due to cost, density scaling, and flexibility, a traditional flex cable would be a desired solution. In order to achieve suitable IO density, however, typical flex cables incur unacceptable conductive losses and cross-talk at the desired dimensions. The competing objectives of maximizing IO density on one hand, and decreasing conductive loss and cross-talk on the other hand, cannot be resolved by typical flex cables, which are uniform cables having the same cross-section at any given location along the cable length.

Accordingly, electrical cables are disclosed that can provide a desired IO routing density while maintaining appropriate signal integrity for applications such as HPC and servers. In one example, an electrical cable can include a transmission line conductor, a ground conductor, and a dielectric material. The dielectric material can have at least a portion with a thickness separating the transmission line conductor and the ground conductor that is variable along a length of the electrical cable. Such a non-uniform cable (e.g., a cable having components or features that vary in size and/or geometry along the length of the cable) can provide high IO density with acceptable conductive losses and cross-talk while maintaining a desired impedance.

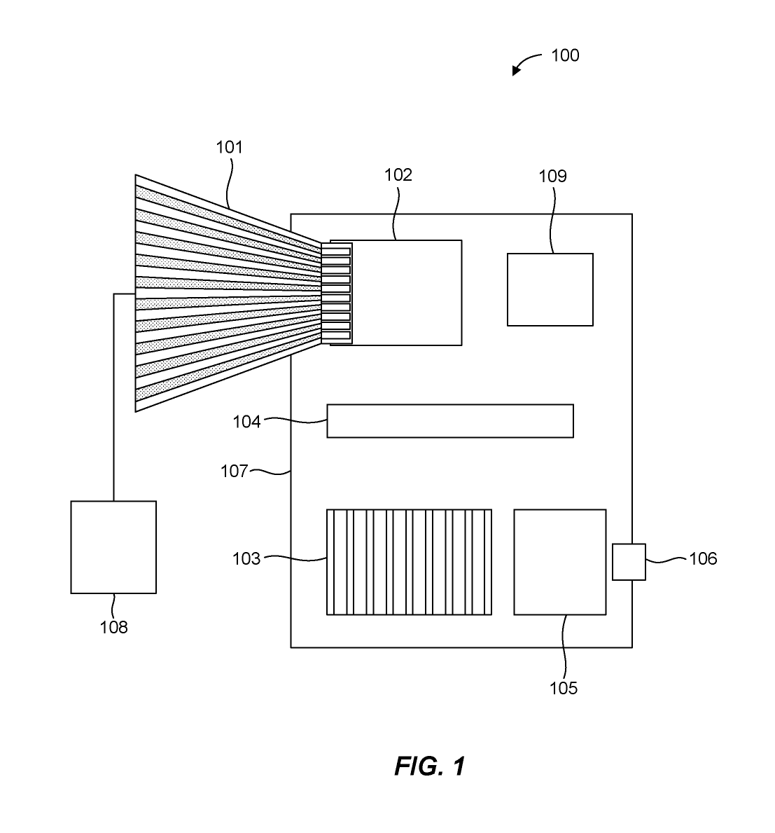

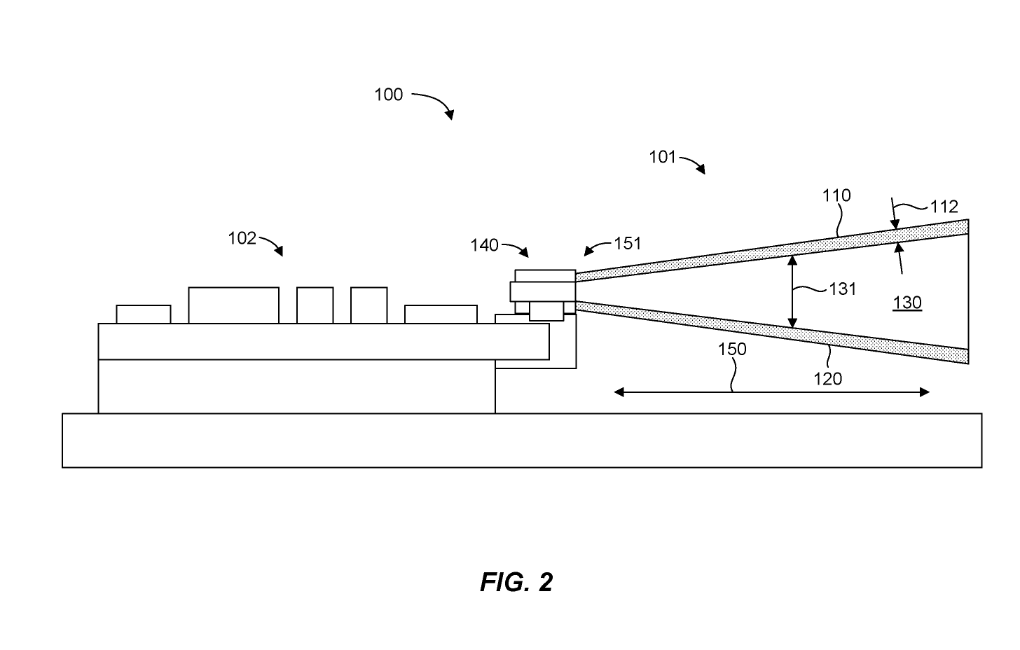

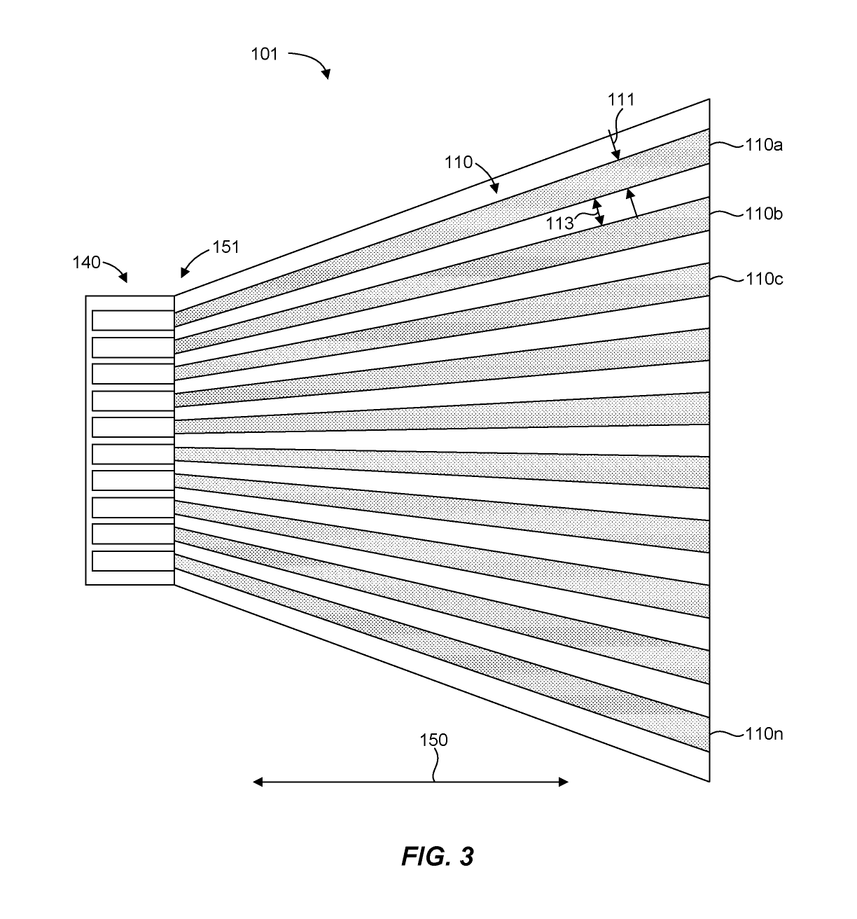

Referring to FIG. 1, an exemplary electronic system 100 is schematically illustrated. The electronic system 100 can be any suitable type of electronic system. For example, the electronic system 100 can comprise any type of computing system, such as a desktop computer, a laptop computer, a tablet computer, a smartphone, a HPC, a server, a wearable device, etc. In general, the electronic system 100 includes an electrical cable 101 and an electronic component 102 operably coupled to one another. A detailed side view of the electrical cable 101 and the electronic component 102 is shown in FIG. 2. FIG. 3 illustrates a top view of the electrical cable 101 isolated from other components. For clarity and simplicity, the electrical cable 101 is shown truncated with only one end illustrated. The electronic component 102 can be any electronic device or component that may be included in an electronic device package, such as a semiconductor device (e.g., a die, a chip, memory, or a processor). The electronic system 100 can further include a cooling system 103 (e.g., a heat sink or spreader and/or active cooling system), a processor, a memory device 104, a radio 105, a port 106, a slot, a battery, or any other suitable device or component of an electronic system. One or more of the devices or components of the electronic system 100 can be mounted on or otherwise associated with a substrate 107 (e.g., a microelectronic package substrate or a motherboard). The electrical cable 101 can interconnect electrical components. For example, the electrical cable 101 can be operably coupled to an electronic component 108 to electrically interconnect the electronic components 102, 108. The electronic component 108 can be remotely located relative to the substrate 107. In other words, the electrical cable 101 can interconnect electronic components that are not mounted on the same substrate. Alternatively, the electrical cable 101 can electrically interconnect electronic components associated with the same substrate. For example, although not specifically illustrated in FIG. 1, the electrical cable 101 can be operably coupled to the electrical component 102 and to an electrical component 109, which is coupled to the substrate 107. Physical routing of the electrical cable 101 between electronic components can be accomplished in any suitable manner, which may be influenced by space constraints or other practical considerations. Other embodiments of the system 100 need not include all of the features specified in FIG. 1, and may include alternative features not specified in FIG. 1.

A primary design consideration for cables interconnecting electronic components, such as for high speed data links between components, is maintaining controlled impedance lines (typically 50Ω single ended or 100 or 85Ω differential, although any suitable impedance value is contemplated). This impedance may be defined based on the type of transmission line (e.g., microstrip, stripline, etc.), the transmission line width, the distance between the transmission line (e.g., signal) and ground (e.g., a ground plane), which may be established by a substrate or dielectric thickness in the cable between the transmission line and ground, and the dielectric constant of the dielectric material. Another design concern is configuring a cable to couple to an electronic component, which may have a very limited area available for coupling with cables or other interconnects. In this case, it may be desirable to maximize IO density in a cable in order to couple with a relatively small area of an electronic component. To achieve high IO density, however, transmission lines within a cable are typically reduced in size and placed closer together, which increases conductive losses and cross-talk among the transmission lines, thus ultimately limiting the length and data rate of the cable. Technology embodiments disclosed herein can provide for tight spacing of transmission line conductors to achieve a desired IO density in an electrical cable with a desired impedance while minimizing cross-talk and losses.

For example, as shown in the side view of FIG. 2, the electrical cable 101 can include a transmission line conductor 110 and a ground conductor 120, represented generally. The electrical cable 101 can also include a dielectric material 130 disposed between the transmission line conductor 110 and the ground conductor 120. The electrical cable 101 can include a connector 140 for coupling the transmission line conductor 110 and the ground conductor 120 to the electronic component 102 (e.g., a top side interconnect in a server package, HPC, etc.). The connector 140 can provide or establish a desired IO density for coupling with the electronic component 102 (see, e.g., the top view of FIG. 3). The IO connection can be limiting in a certain respect to the design of the cable 101. However, dimensions of various features and components of the cable 101 can vary or change away from the connector 140 in order to provide several advantages of the present technology, such as maintaining a desired impedance, reducing cross-talk, and/or reducing conductive losses, thereby providing longer reaches and higher data rates in a cable having a desired IO density.

For example, at least a portion of the dielectric material 130 can have a thickness 131 separating the transmission line conductor 110 and the ground conductor 120 that is variable along a length 150 of the electrical cable 101. A non-uniform dielectric thickness can enable good impedance matching to be maintained. In one aspect, the dielectric thickness 131 and a dielectric constant can vary along the length 150 to maintain an impedance match. In another aspect, the dielectric thickness 131 and transmission line conductor width (discussed in more detail below) can vary along the length 150 to maintain an impedance match. The connector 140 is disposed at an end 151 of the electrical cable 101 where the thickness 131 of the dielectric material 130 is at a minimum in order to increase IO density.

In some embodiments, the distance between the transmission line and ground as well as a width of the transmission line can influence the impedance in a cable. Thus, in addition to increasing the dielectric thickness 131, a width of the transmission line conductor 110 can also be increased along the length 150 (e.g., away from the connector 140) in order to maintain a desired impedance. For example, as shown in the top view of FIG. 3, the transmission line conductor 110 can include a plurality of transmission line conductors 110a-n. The transmission line conductors 110a-n can be variable in width 111 along the length 150 of the electrical cable 101 to achieve a desired impedance. Varying a dimension of the transmission line conductor, such as width discussed above, can also impact conductive losses. For example, increasing the cross-sectional area of the transmission line conductors 110a-n by increasing the width 111 (FIG. 3) and/or a thickness 112 (FIG. 2) along the length 150 (e.g., away from the connector 140) of the electrical cable 101 can reduce or minimize conductive losses in the cable 101. Thus, varying the width of the transmission line conductor can influence impedance as well as conductive losses.

In one aspect, shown in FIG. 3, a gap between adjacent transmission line conductors (e.g., channel to channel spacing) can be variable along the length 150 of the electrical cable 101 to influence cross-talk between the adjacent transmission line conductors. For example, a gap or distance 113 between adjacent transmission line conductors 110a and 110b can be increased along the length 150 (e.g., away from the connector 140) to decrease cross-talk among the transmission line conductors.

In one example, utilizing a stripline and a starting dielectric thickness of 50 μm, 4 IO/mm could be achieved with 20 dB isolation. However, the loss would be on the order of 0.33 dB/cm at 10 GHz. By increasing the dielectric thickness to 100 μm, the loss could be reduced to 0.24 dB/cm in the region where the dielectric thickness is 100 μm. For an example line 18 inches in length, the loss could be reduced from about 15 dB to less than 12 dB. A 3 dB savings results in double the power at the receiver. Although this represents a single example, higher IO densities can be achieved by varying the dielectric constant, launching line width, cross talk requirements, and transmission line type. Greater power reductions can be realized by further increasing the thickness of the dielectric.

An electrical cable as disclosed herein can therefore be configured with geometry that is varied along its length to provide high IO density while maintaining an appropriate impedance, as well as having reduced cross-talk and conductive losses along the length of the cable that enable longer reaches and higher data rates. The variable sizes and geometries discussed herein can be of any suitable dimension or configuration and may only be limited by practical considerations such as space constraints, manufacturing capabilities, etc. Such non-uniform and variable geometries of the cable can be achieved by any suitable technique or process. For example, geometries of the dielectric material (e.g., polyimide, polyether ether ketone, etc.), transmission line and/or ground conductors (e.g., copper) can be formed by an additive manufacturing technique, such as 3D printing. In one aspect, a transmission line and/or ground conductor variable cross-section can be formed by rolling a copper sheet with a variable force. In another aspect, a transmission line and/or ground conductor variable cross-section can be formed by electroplating with the only electrode at a relatively thick end of the conductor. The dielectric constant can be varied and controlled (e.g., along the length of the cable) by a number of manufacturing processes, such as by utilizing 3D printing and/or layering dielectric materials to achieve a non-uniform or non-homogeneous dielectric material. Aside from the non-uniform characteristics and attributes of the electrical cables disclosed herein, some embodiments may be similar in general construction to typical flex cables.

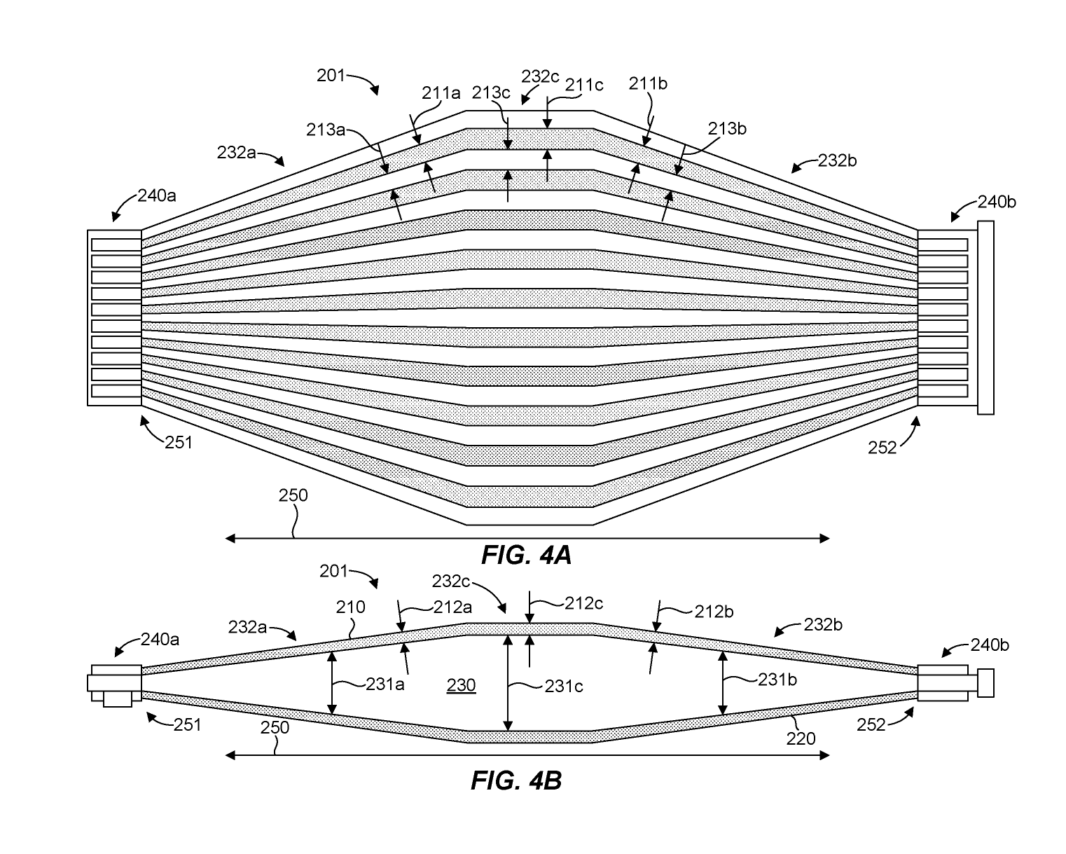

FIGS. 4A and 4B illustrate an electrical cable 201 in accordance with another example of the present disclosure. As with the electrical cable 101 discussed above, the electrical cable 201 can include a transmission line conductor 210, a ground conductor 220, and a dielectric material 230 disposed between the transmission line conductor 210 and the ground conductor 220. The electrical cable 201 can also include connectors 240a, 240b for coupling the transmission line conductor 210 to electronic components (not shown). The connectors 240a, 240b are at opposite ends 251, 252 of the cable 201. Each connector 240a, 240b can provide or establish a desired IO density for coupling with a given electronic component and can be configured to interface with or engage any type of mating connector interface feature. Thus, the geometries of the various cable 201 features can be the same or different at the opposite ends 251, 252 of the cable 201. For example, respective thicknesses 231a, 231b of portions 232a, 232b of the dielectric material 230 and transmission line conductor width 211a, 211b, thickness 212a, 212b, and spacing 213a, 213b can vary along a length 250 of the cable 201 in a similar or different manner, which may be influenced by the 10 density requirements of each connector 240a, 240b. As mentioned above, the variable sizes and geometries of the cable 201 can be of any suitable dimension or configuration. For example, once the dielectric thickness, and transmission line conductor width, thickness, and/or spacing have increased along the length from a connector to achieve suitable cable characteristics (e.g., impedance cross-talk, and conductive losses) the sizes and geometries can remain constant for a portion of the cable. Thus, in one aspect, a middle portion 232c of the dielectric material 230 can have a thickness 231c that is constant along the length 250 of the electrical cable 201. Similarly, the transmission line conductor width 211c, thickness 212c, and/or spacing 213c in the middle portion of the cable 201 can be constant along the length 250 of the cable.

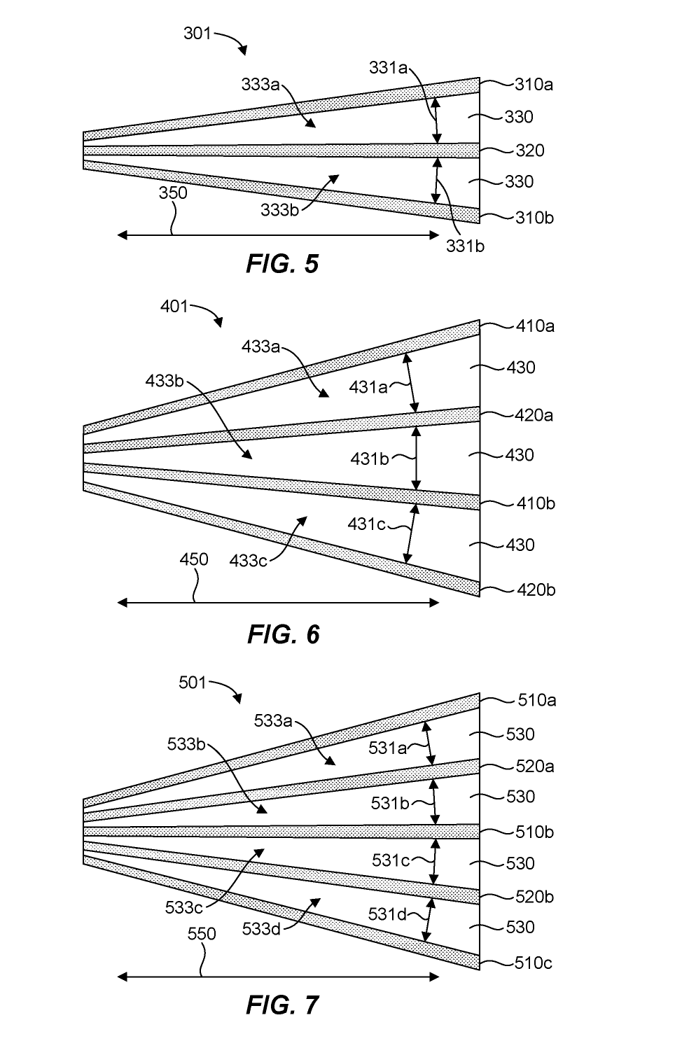

In one aspect of the present technology, electrical cables can be configured with multiple layers of transmission line conductors and or ground conductors, several examples of which are shown in FIGS. 5-7. Certain portions of the cables (e.g., connectors) have been omitted for clarity and simplicity. FIG. 5 illustrates an electrical cable 301 that has three conductive elements. For example, the electrical cable 301 can have two transmission line conductors 310a, 310b disposed about opposite sides of a ground conductor 320. In addition, the electrical cable 301 can have dielectric material 330 that separates the transmission line conductors 310a, 310b from the ground conductor 320. In particular, a portion 333a of the dielectric material 330 can separate the transmission line conductor 310a from the ground conductor 320, and a portion 333b of the dielectric material 330 can separate the transmission line conductor 310b from the ground conductor 320. The dielectric material can be the same or different in the dielectric material portions 333a, 333b. Thicknesses 331a, 331b of the dielectric portions 333a, 333b, respectively, can vary along a length 350 of the cable 301. The dielectric thicknesses 331a, 331b can vary along the length 350 in a similar or different manner.

FIG. 6 illustrates an electrical cable 401 that has four conductive elements. In one embodiment, the electrical cable 401 can have transmission line conductors 410a, 410b and ground conductors 420a, 420b arranged to alternate the transmission line conductors with the ground conductors. For example, the ground conductor 420a can be disposed between the transmission line conductors 410a, 410b, and the transmission line conductor 410b can be disposed between the ground conductors 420a, 420b. In addition, the electrical cable 401 can have dielectric material 430 that separates the transmission line conductors 410a, 410b from the ground conductors 420a, 420b. In particular, a portion 433a of the dielectric material 430 can separate the transmission line conductor 410a from the ground conductor 420a, a portion 433b of the dielectric material 430 can separate the transmission line conductor 410b from the ground conductor 420a, and a portion 433c of the dielectric material 430 can separate the transmission line conductor 410b from the ground conductor 420b. The dielectric material can be the same or different in the dielectric material portions 433a-c. Thicknesses 431a-c of the dielectric portions 433a-c, respectively, can vary along a length 450 of the cable 401. The dielectric thicknesses 431a-c can vary along the length 450 in a similar or different manner. In another embodiment, the outer conductive elements can be transmission line conductors and the inner conductive elements can be ground conductors. Thus, in this embodiment, the transmission line conductors can be disposed about the ground conductors.

FIG. 7 illustrates an electrical cable 501 that has five conductive elements. The electrical cable 501 can have transmission line conductors 510a-c and ground conductors 520a, 520b arranged to alternate the transmission line conductors with the ground conductors. For example, the ground conductor 520a can be disposed between the transmission line conductors 510a, 510b, and the ground conductor 510b can be disposed between the transmission line conductors 510b, 510c. In addition, the electrical cable 501 can have dielectric material 530 that separates the transmission line conductors 510a-c from the ground conductors 520a, 520b. In particular, a portion 533a of the dielectric material 530 can separate the transmission line conductor 510a from the ground conductor 520a, a portion 533b of the dielectric material 530 can separate the transmission line conductor 510b from the ground conductor 520a, a portion 533c of the dielectric material 530 can separate the transmission line conductor 510b from the ground conductor 520b, and a portion 533d of the dielectric material 530 can separate the transmission line conductor 510c from the ground conductor 520b. The dielectric material can be the same or different in the dielectric material portions 533a-d. Thicknesses 531a-d of the dielectric portions 533a-d, respectively, can vary along a length 550 of the cable 501. The dielectric thicknesses 531a-d can vary along the length 550 in a similar or different manner.

With the examples provided in FIGS. 5-7, it should be recognized that multi layer electrical cables as disclosed herein can be of any suitable configuration, such as including any suitable number of layers and having transmission line conductors and ground conductors disposed in any suitable arrangement.

FIG. 8 illustrates an electrical cable 601 in accordance with another example of the present disclosure. As with other electrical cables disclosed herein, the electrical cable 601 can include a transmission line conductor 610, a ground conductor 620, and a dielectric material 630 disposed between the transmission line conductor 610 and the ground conductor 620. The electrical cable 601 can also include connectors (only connector 640 is shown) for coupling the transmission line conductor 610 to electronic components. The dielectric material 630 has a portion 632a with a constant thickness 631a and a portion 632b with a variable thickness 631b. In this example, the dielectric material portion 632a with a constant thickness 631a is between the dielectric material portion 632b with a variable thickness 631b and the connector 640. Such a cable configuration with a reduced cable size extending for a given distance from the connector 640 may be desirable, for example, due to space constraints around the cable near the connector.

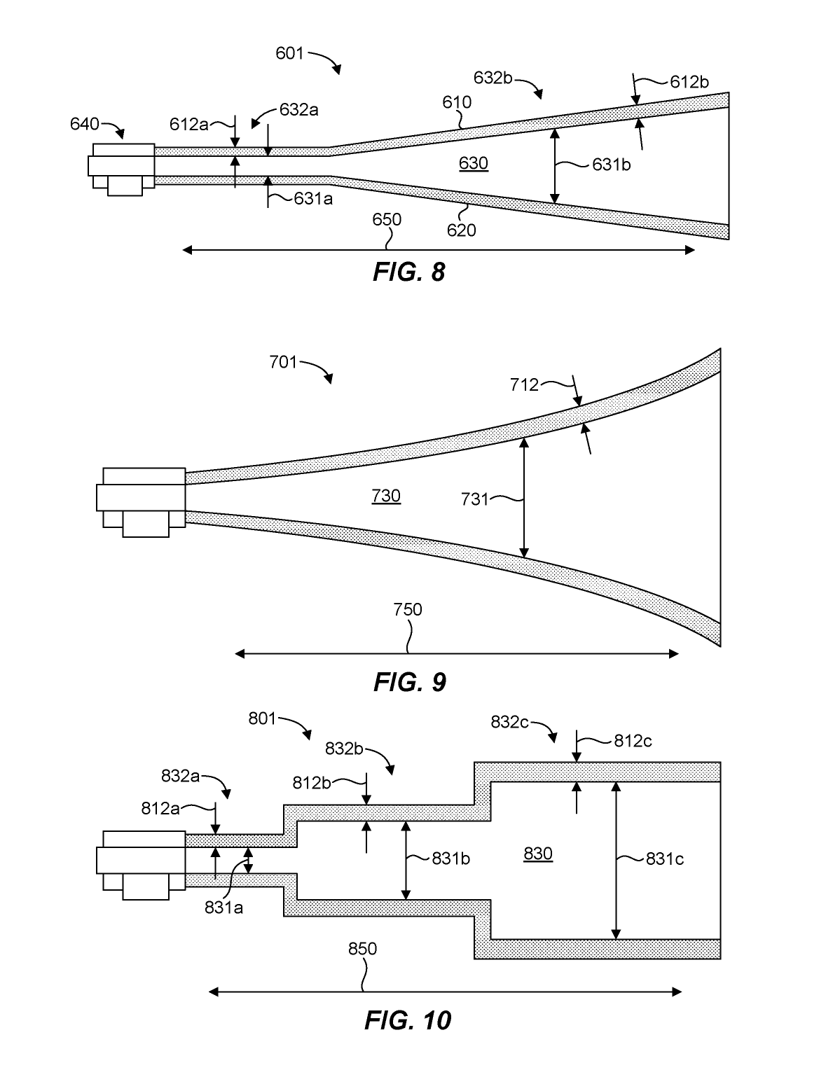

It should be noted that features of an electrical cable as disclosed herein, such as the dielectric material thickness and transmission line conductor geometry (e.g., width and thickness) and spacing, can be constant or variable as desired and, when variable, can vary in any suitable manner. For example, as shown in FIG. 8, the dielectric thickness 631b is shown as varying linearly along a length 650 of the cable 601, the transmission line conductor thickness 612a is shown as constant along the length 650 of the cable 601, and the transmission line conductor thickness 612b is shown as varying linearly along the length 650 of the cable 601. In another example, FIG. 9 illustrates an electrical cable 701 with a dielectric thickness 731 varying along a length 750 of the cable 701. In this case, the dielectric thickness 731 is shown as varying nonlinearly (e.g., exponentially) along the length 750 of the cable 701. A transmission line conductor thickness 712 is also shown as varying along the length 750 of the cable 701. In yet another example, FIG. 10 illustrates an electrical cable 801 with a dielectric thickness varying along a length 850 of the cable 801. In this case, dielectric thicknesses 831a-c of dielectric portions 832a-c, respectively, are shown varying as a step-function along the length 850 of the cable 801. Transmission line conductor thicknesses 812a-c associated with each dielectric portion 832a-c, respectively, are also shown as varying along the length 850 of the cable 801. In this case, the each of the individual transmission line conductor thicknesses 812a-c is constant along the length 850, but are different from one another.

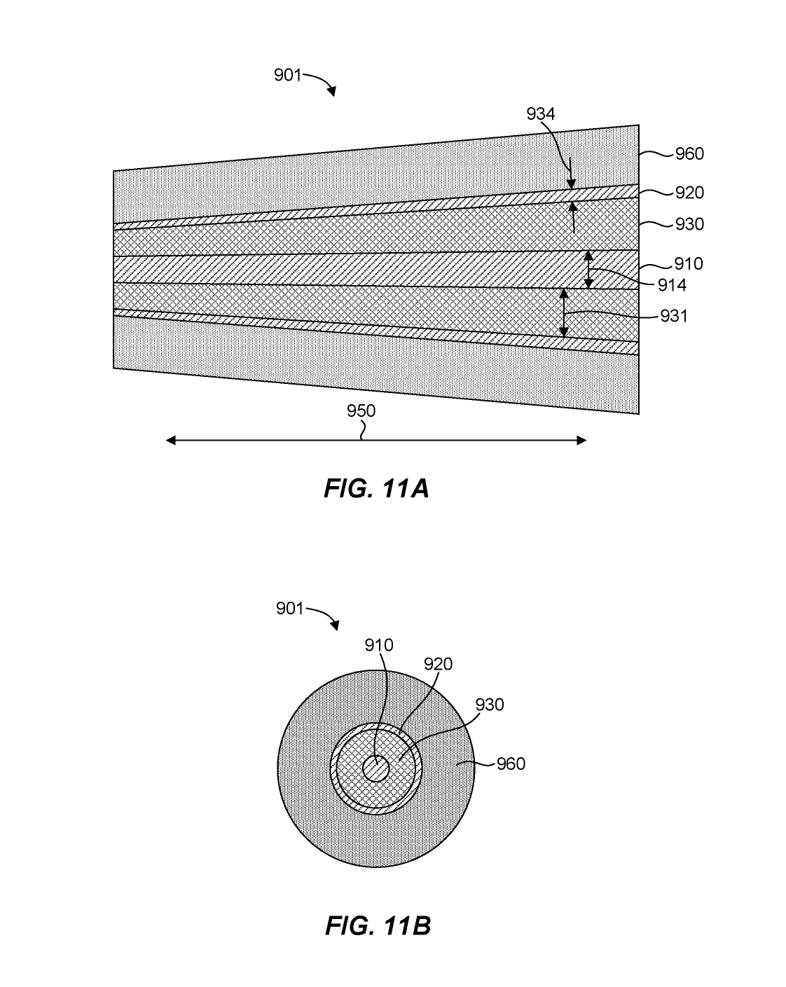

FIGS. 11A and 11B illustrate an electrical cable 901 in accordance with another example of the present disclosure. As with other electrical cables disclosed herein, the electrical cable 901 can include a transmission line conductor 910, a ground conductor 920, and a dielectric material 930 disposed between the transmission line conductor 910 and the ground conductor 920. The electrical cable 901 can also include connectors (not shown) for coupling the transmission line conductor 910 to electronic components. In this case, the transmission line conductor 910, the dielectric material 930, and the ground conductor 920 are arranged in a coaxial configuration. A diameter 914 of the transmission line conductor 910, a dielectric thickness 931, and/or a ground conductor shell thickness 934 can be constant or vary along a length 950 of the cable 901 in order to achieve a desired impedance and/or reduced conductive losses. The electrical cable 901 can also include an outer jacket 960 to provide protection for the interior components of the cable.

### Examples

The following examples pertain to further embodiments.

In one example there is provided an electrical cable comprising a transmission line conductor, a ground conductor, and a dielectric material having at least a portion with a thickness separating the transmission line conductor and the ground conductor that is variable along a length of the electrical cable.

In one example of an electrical cable, the transmission line conductor is variable in width along the length of the electrical cable.

In one example of an electrical cable, the transmission line conductor is variable in thickness along the length of the electrical cable.

In one example of an electrical cable, the transmission line conductor is variable in cross-sectional area along the length of the electrical cable.

In one example of an electrical cable, the transmission line conductor comprises a plurality of transmission line conductors.

In one example of an electrical cable, a gap between adjacent transmission line conductors is variable along the length of the electrical cable.

In one example of an electrical cable, the transmission line conductor, the dielectric material, and the ground conductor are arranged in a coaxial configuration.

In one example of an electrical cable, the thickness varies linearly along the length of the electrical cable.

In one example of an electrical cable, the thickness varies non-linearly along the length of the electrical cable.

In one example of an electrical cable, the thickness varies exponentially along the length of the electrical cable.

In one example, an electrical cable further comprises a connector for coupling the transmission line conductor to an electronic component.

In one example of an electrical cable, the connector is disposed at an end of the electrical cable where the thickness of the dielectric material is at a minimum.

In one example, an electrical cable further comprises a second connector disposed at an end of the electrical cable opposite the first connector.

In one example of an electrical cable, a second portion of the dielectric material has a second thickness separating the transmission line conductor and the ground conductor that is constant along the length of the electrical cable.

In one example of an electrical cable, the second portion of the dielectric material with a constant second thickness is between the first portion of the dielectric material with a variable first thickness and a connector.

In one example, an electrical cable further comprises a second transmission line conductor disposed such that the first and second transmission line conductors are about opposite sides of the ground conductor, wherein the dielectric material has a portion with a second thickness that separates the second transmission line conductor and the ground conductor and is variable along the length of the electrical cable.

In one example of an electrical cable, the second transmission line conductor is variable in width along the length of the electrical cable.

In one example of an electrical cable, the second transmission line conductor is variable in thickness along the length of the electrical cable.

In one example of an electrical cable, the second transmission line conductor is variable in cross-sectional area along the length of the electrical cable.

In one example of an electrical cable, the second transmission line conductor comprises a plurality of second transmission line conductors.

In one example of an electrical cable, a gap between adjacent second transmission line conductors is variable along the length of the electrical cable.

In one example, an electrical cable further comprises a second ground conductor disposed such that the first and second ground conductors are between the first and second transmission line conductors, wherein the dielectric material has a portion with a third thickness that separates the second transmission line conductor and the second ground conductor and is variable along the length of the electrical cable.

In one example of an electrical cable, the second transmission line conductor is variable in width along the length of the electrical cable.

In one example of an electrical cable, the second transmission line conductor is variable in thickness along the length of the electrical cable.

In one example of an electrical cable, the second transmission line conductor is variable in cross-sectional area along the length of the electrical cable.

In one example of an electrical cable, the second transmission line conductor comprises a plurality of second transmission line conductors.

In one example of an electrical cable, a gap between adjacent second transmission line conductors is variable along the length of the electrical cable.

In one example, an electrical cable further comprises a second ground conductor disposed such that the first and second ground conductors are about opposite sides of the first transmission line conductor, wherein the dielectric material has portion with a third thickness that separates the first transmission line conductor and the second ground conductor and is variable along the length of the electrical cable.

In one example of an electrical cable, the second transmission line conductor is variable in width along the length of the electrical cable.

In one example of an electrical cable, the second transmission line conductor is variable in thickness along the length of the electrical cable.

In one example of an electrical cable, the second transmission line conductor is variable in cross-sectional area along the length of the electrical cable.

In one example of an electrical cable, the second transmission line conductor comprises a plurality of second transmission line conductors.

In one example of an electrical cable, a gap between adjacent second transmission line conductors is variable along the length of the electrical cable.

In one example, an electrical cable further comprises a third ground conductor disposed such that the first and third ground conductors are about opposite sides of the second transmission line conductor, wherein the dielectric material has portion with a fourth thickness that separates the second transmission line conductor and the third ground conductor and is variable along the length of the electrical cable.

In one example of an electrical cable, the second transmission line conductor is variable in width along the length of the electrical cable.

In one example of an electrical cable, the second transmission line conductor is variable in thickness along the length of the electrical cable.

In one example of an electrical cable, the second transmission line conductor is variable in cross-sectional area along the length of the electrical cable.

In one example of an electrical cable, the second transmission line conductor comprises a plurality of second transmission line conductors.

In one example of an electrical cable, a gap between adjacent second transmission line conductors is variable along the length of the electrical cable.

In one example there is provided an electronic system comprising an electronic component, and an electrical cable operably coupled to the electronic component.

In one example, an electronic system further comprises a substrate, wherein the electronic component is coupled to the substrate.

In one example of an electronic system, the substrate comprises a motherboard.

In one example of an electronic system, the electronic system further comprises a processor, a memory device, a radio, a slot, a port, or a combination thereof operably coupled to the motherboard.

In one example, an electronic system further comprises a second electronic component operably coupled to the first electronic component.

In one example of an electronic system, the second electronic component is coupled to the substrate.

In one example of an electronic system, the electronic system comprises a computing system.

In one example of an electronic system, the computing system comprises a desktop computer, a laptop, a tablet, a smartphone, a HPC, a server, a wearable device, or a combination thereof.

In one example there is provided a method for making an electrical cable comprising obtaining a dielectric material, forming the dielectric material having at least a portion with a thickness that is variable along a length, and disposing a transmission line conductor and a ground conductor about the dielectric material such that the thickness of the dielectric material separates the transmission line conductor and the ground conductor.

In one example, a method for making an electrical cable further comprises forming the transmission line conductor with a width that varies along the length.

In one example, a method for making an electrical cable further comprises forming the transmission line conductor with a thickness that varies along the length.

In one example, a method for making an electrical cable further comprises forming the transmission line conductor with a cross-sectional area that varies along the length.

In one example of a method for making an electrical cable, the transmission line conductor comprises a plurality of transmission line conductors.

In one example, a method for making an electrical cable further comprises forming a gap between adjacent transmission line conductors that is variable along the length.

In one example of a method for making an electrical cable, the transmission line conductor, the dielectric material, and the ground conductor are arranged in a coaxial configuration.

In one example of a method for making an electrical cable, the thickness of the dielectric material varies linearly along the length.

In one example of a method for making an electrical cable, the thickness of the dielectric material varies non-linearly along the length.

In one example of a method for making an electrical cable, the thickness of the dielectric material varies exponentially along the length of the electrical cable.

In one example, a method for making an electrical cable further comprises electrically coupling a connector to the transmission line conductor to facilitate coupling the transmission line conductor to an electronic component.

In one example of a method for making an electrical cable, the connector is disposed at an end of the electrical cable where the thickness of the dielectric material is at a minimum.

In one example, a method for making an electrical cable further comprises electrically coupling a second connector to the transmission line conductor at an end of the electrical cable opposite the first connector.

In one example, a method for making an electrical cable further comprises forming a second portion of the dielectric material with a second thickness separating the transmission line conductor and the ground conductor that is constant along the length.

In one example of a method for making an electrical cable, the second portion of the dielectric material with a constant second thickness is between the first portion of the dielectric material with a variable first thickness and a connector.

Circuitry used in electronic components or devices (e.g. a die) of an electronic device package can include hardware, firmware, program code, executable code, computer instructions, and/or software. Electronic components and devices can include a non-transitory computer readable storage medium which can be a computer readable storage medium that does not include signal. In the case of program code execution on programmable computers, the computing devices recited herein may include a processor, a storage medium readable by the processor (including volatile and non-volatile memory and/or storage elements), at least one input device, and at least one output device. Volatile and non-volatile memory and/or storage elements may be a RAM, EPROM, flash drive, optical drive, magnetic hard drive, solid state drive, or other medium for storing electronic data. Node and wireless devices may also include a transceiver module, a counter module, a processing module, and/or a clock module or timer module. One or more programs that may implement or utilize any techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

While the forgoing examples are illustrative of the specific embodiments in one or more particular applications, it will be apparent to those of ordinary skill in the art that numerous modifications in form, usage and details of implementation can be made without departing from the principles and concepts articulated herein.

What is claimed is:

1. An electrical cable, comprising:
a transmission line conductor;
a ground conductor; and
a dielectric material having at least a portion with a thickness separating the transmission line conductor and the ground conductor that is variable along a length of the electrical cable.

2. The electrical cable of claim 1, wherein the transmission line conductor is variable in width along the length of the electrical cable.

3. The electrical cable of claim 1, wherein the transmission line conductor is variable in thickness along the length of the electrical cable.

4. The electrical cable of claim 1, wherein the transmission line conductor is variable in cross-sectional area along the length of the electrical cable.

5. The electrical cable of claim 1, wherein the transmission line conductor comprises a plurality of transmission line conductors.

6. The electrical cable of claim 1, wherein the transmission line conductor, the dielectric material, and the ground conductor are arranged in a coaxial configuration.

7. The electrical cable of claim 1, wherein the thickness varies linearly along the length of the electrical cable.

8. The electrical cable of claim 1, wherein the thickness varies non-linearly along the length of the electrical cable.

9. The electrical cable of claim 1, further comprising a connector for coupling the transmission line conductor to an electronic component.

10. The electrical cable of claim 1, wherein a second portion of the dielectric material has a second thickness separating the transmission line conductor and the ground conductor that is constant along the length of the electrical cable.

11. The electrical cable of claim 1, further comprising a second transmission line conductor disposed such that the first and second transmission line conductors are about opposite sides of the ground conductor, wherein the dielectric material has a portion with a second thickness that separates the second transmission line conductor and the ground conductor and is variable along the length of the electrical cable.

12. The electrical cable of claim 11, wherein the second transmission line conductor is variable in width along the length of the electrical cable.

13. The electrical cable of claim 11, wherein the second transmission line conductor is variable in thickness along the length of the electrical cable.

14. The electrical cable of claim 1, wherein the second transmission line conductor is variable in cross-sectional area along the length of the electrical cable.

15. The electrical cable of claim 1, wherein the second transmission line conductor comprises a plurality of second transmission line conductors.

16. The electrical cable of claim 11, further comprising a second ground conductor disposed such that the first and second ground conductors are between the first and second transmission line conductors, wherein the dielectric material has a portion with a third thickness that separates the second transmission line conductor and the second ground conductor and is variable along the length of the electrical cable.

17. The electrical cable of claim 11, further comprising a second ground conductor disposed such that the first and second ground conductors are about opposite sides of the first transmission line conductor, wherein the dielectric material has portion with a third thickness that separates the first transmission line conductor and the second ground conductor and is variable along the length of the electrical cable.

18. An electronic system, comprising:
an electronic component; and
an electrical cable as in claim 1, operably coupled to the electronic component.

19. The electronic system of claim 18, further comprising a substrate, wherein the electronic component is coupled to the substrate.

20. The electronic system of claim 19, wherein the substrate comprises a motherboard.

21. The electronic system of claim 20, wherein the electronic system further comprises a processor, a memory device, a radio, a slot, a port, or a combination thereof operably coupled to the motherboard.

22. The electronic system of claim 19, further comprising a second electronic component operably coupled to the first electronic component.

23. The electronic system of claim 22, wherein the second electronic component is coupled to the substrate.

24. The electronic system of claim 19, wherein the electronic system comprises a computing system.

25. The electronic system of claim 24, wherein the computing system comprises a desktop computer, a laptop, a tablet, a smartphone, a HPC, a server, a wearable device, or a combination thereof.
